(19) United States
(12) Patent Application Publication
(10) Pub. No.: US 2025/0205749 A1
(43) Pub. Date: Jun. 26, 2025

(54) CONTACTING CLEANING SYSTEM AND METHOD OF REMOVING AN ADHESIVE ROLL FROM THE CONTACT CLEANING SYSTEM

(71) Applicant: Illinois Tool Works Inc., Glenview, IL (US)

(72) Inventor: Matt BENNING, Glasgow (GB)

(21) Appl. No.: 18/968,413

(22) Filed: Dec. 4, 2024

(30) Foreign Application Priority Data
Dec. 21, 2023 (GB) 2319750.2

(51) Int. Cl. B08B 1/32

(52) U.S. Cl. CPC B08B 1/32

(57) ABSTRACT

Disclosed example contact cleaning systems include: an adhesive roll comprising at least one adhesive sheet, wherein the at least one adhesive sheet comprises a leading edge; and an adhesive sheet removal device comprising a pick-up element. The pick-up element is configured to be brought into contact with the leading edge of the at least one adhesive sheet and apply a vacuum to the leading edge to lift the leading edge away from the adhesive roll. A method of removing an adhesive roll is also disclosed, comprising: providing an adhesive roll comprising at least one adhesive sheet, wherein the at least one adhesive sheet comprises a leading edge; detecting the position of the leading edge; and applying a vacuum to the leading edge of the at least one adhesive sheet to lift the leading edge away from the adhesive roll.

### RELATED APPLICATIONS

The present application claims the benefit of United Kingdom (GB) Patent Application No. 2319750.2, filed Dec. 21, 2023, entitled “CONTACTING CLEANING SYSTEM AND METHOD OF REMOVING AN ADHESIVE ROLL FROM THE CONTACT CLEANING SYSTEM.” The entirety of United Kingdom (GB) Patent Application No. 2319750.2 is expressly incorporated herein by reference.

### FIELD OF THE DISCLOSURE

The present disclosure relates to a contact cleaning system and an adhesive roll for a contact cleaning system. A method of removing an adhesive sheet from the adhesive roll is also disclosed.

### BACKGROUND

Contact cleaning is used to clean substrate surfaces. Once cleaned, the substrate surface may be used in a variety of sophisticated processes such as in the manufacturing of electronics, photovoltaics and flat panel displays. Usually, a rubber or elastomeric cleaning roller is used to remove contaminating particles from a substrate surface and an adhesive roll can then be used to remove the contaminating particles or debris from the cleaning roller. This allows the cleaning roller to maximise its efficiency in removing contaminating particles from the substrate surface.

In contact cleaning, an adhesive roll typically comprises a wound length, or sheeted lengths, of substrate material wrapped around a core. The substrate material includes an adhesive side which can be used to remove or collect the debris from the surface of the cleaning roller. A length of adhesive material prior to cleaning is substantially uncovered by debris and has a relatively high level of tack.

As the adhesive roll removes debris, the debris covers the adhesive surface area and the level of tack of the adhesive material will become lower as the debris covers a greater proportion of the adhesive surface area. Accordingly, the adhesive material will lose effectiveness. When the performance of the adhesive material falls below the required threshold the adhesive material is spent and must be removed from the adhesive roll.

To remove spent adhesive material from an adhesive roll, an adhesive sheet removal device must contact an end of the adhesive material to lift the material from the adhesive roll. One example of an adhesive sheet removal device is a device having an adhesive surface. However, the adhesive surface may not be strong enough to lift the adhesive sheet from the adhesive roll, or the adhesive surface may lift more than one adhesive sheet from the adhesive roll.

In certain known examples, a further adhesive surface is used to contact and lift the spent adhesive sheet. However, this system has the drawback that the further adhesive surface necessarily comes into contact with a contaminated sheet, meaning that further adhesive surface will itself be contaminated and require renewing or replacing. Such a system adds unwanted complexity and expense to the process of removing a spent adhesive sheet.

It is an object of embodiments of this disclosure to at least mitigate one or more of the problems of the prior art.

### SUMMARY

Aspects and embodiments of the disclosure provide an adhesive roll for use in a contact cleaning system, a contact cleaning system, and a method of manufacturing an adhesive roll, as claimed in the appended claims.

In one aspect, there is provide a contact cleaning system including: an adhesive roll including at least one adhesive sheet, wherein the at least one adhesive sheet includes a leading edge; and an adhesive sheet removal device includes a pick-up element; wherein the pick-up element is configured to be brought into contact with the leading edge of the at least one adhesive sheet and apply a vacuum to the leading edge to lift the leading edge away from the adhesive roll.

The vacuum of the pick-up element may apply a sheer force to the leading edge of the at least one adhesive sheet to lift the leading edge away from the adhesive roll.

The pick-up element may include a hollow element configured to convey the vacuum to the leading edge of the at least one adhesive sheet.

The pick-up element may apply a vacuum to the leading edge using a series of vacuum pockets configured to align along the axial length of the adhesive roll. The pick-up element may include a series of hollow elements arranged to be spaced along the axial length of the adhesive roll in use. The series of hollow elements may be spaced apart from one another along the axial length. In this way, the pick-up element may be adapted to apply the vacuum intermittently along the leading edge. The applied vacuum is thereby more intense in localised regions along the leading edge.

The adhesive sheet removal device may further include a waste roller, and where the pick-up element is configured to transfer the leading edge of the at least one adhesive sheet to the waste roller.

The pick-up element may be moveable relative to the adhesive sheet removal device, for example, by pivoting or translating within the adhesive sheet removal device. The pick-up element is moveable from a pick-up position, in which the pick-up element is oriented towards the adhesive roll for lifting the leading edge of the outermost layer of the adhesive sheet, to a transfer position, in which the pick-up element is oriented towards the waste roller to transfer the leading edge onto the waste roller.

The pick-up element may be moveable to a stowed position in which the pick-up element is disengaged from both the adhesive roll and from the waste roller.

The pick-up element may be pivotable between the adhesive roll and the waste roller to transfer the leading edge of the at least one adhesive sheet to the waste roller.

The pick-up element may be translatable along a longitudinal axis between the adhesive roll and the waste roller to transfer the leading edge of the at least one adhesive sheet to the waste roller.

The adhesive sheet removal device may include a heating element configured to heat the at least one adhesive sheet that is received by the waste roller. The heating element may be configured to heat the at least one adhesive sheet to a temperature in a range of: from 100 degrees centigrade to 170 degrees centigrade, preferably in one or more range of: from 105 degrees centigrade to 115 degrees centigrade, from 120 degrees centigrade to 130 degrees centigrade, or from 130 degrees centigrade to 170 degrees centigrade. The temperature or temperature range may be selected according to the material of the adhesive sheet, for example to be at or near the melting point of a thermoplastic release layer, or a base layer of the adhesive sheet.

The adhesive sheet removal device may include a pressure element configured to apply a pressure to the at least one adhesive sheet as it is contacts the waste roller to adhere the at least one adhesive sheet to the waste roller. That is, the pressure element may be configured to apply a pressure to the leading edge of the at least one adhesive sheet received by the waste roller. The pressure element may be configured to apply a pressure of at least 0.1 Newtons per centimetre squared (N/cm²). The pressure element may be configured to apply a pressure in a range of from 0.1 to 2.8 Newtons per centimetre squared, preferably in a range of from 0.5 to 2.0 Newtons per centimetre squared.

The heating element may operable engage with the pressure element such that the at least one adhesive sheet removed from the adhesive roll is heated and pressed against the waste roller as it contacts the waste roller.

The pressure applied by the pressure element may be adapted according to the temperature that the at least one adhesive sheet is heated to by the heating element. The applied pressure may be a maximal applied pressure when the temperature is below the melting point of any thermoplastic release layer in the adhesive sheet. A maximal applied pressure may be in a range of from 2.0 to 2.8 Newtons per centimetre squared. Alternative, when the at least one adhesive sheet is heated to the melting point of the thermoplastic release layer, then the applied pressure may be a minimal pressure. A minimal applied pressure may be in a range of from 0.1 to 1.0 Newtons per centimetre squared.

The adhesive roll may include a roll core, and at least one adhesive sheet wound over the roll core, wherein the or each adhesive sheet includes a leading edge. The leading edge of one or more of the at least one adhesive sheets may include an indicator.

The indicator may be a fluorescent indicator, for example a fluorescent indicator including a fluorescent ink.

The indicator may be a phosphorescent indicator, for example a phosphorescent indicator including a phosphorescent ink.

The indicator may include an indelible indicator. Typically, the indelible indicator is a visible in light having a wavelength in the range of from 400 nanometres to 700 nanometres.

The indicator may be located at a predetermined circumferential position on the roll core. That is the indicator may be located at a predetermined circumferential position on an outer surface of the roll core. For example, the indicator may be a dot of indicator on the outer surface, or may form a line of indicator on the outer surface wherein the line of indicator extends in a direction parallel to the roll core rotational axis.

The leading edge of at least one adhesive sheet may include a leading edge portion, wherein the indicator extends along at least the leading edge portion.

The leading edge may extend parallel to the rotational axis of the adhesive roll, or at an angle to the rotational axis of the adhesive roll, such as at a diagonal across the axial length of the adhesive roll. The leading edge may wrap helically around the adhesive roll.

The leading edge may be cut at an angle, typically a non-perpendicular angle, to the length of the continuous adhesive sheet. That is, the leading edge may be cut at angle to a perpendicular to the substrate surface of the adhesive substrate material. The leading edge may be cut with a tapered leading edge. In these ways, the leading edge forms a gradually inclined surface at the boundary of adjacent layers of adhesive sheet. The outermost adhesive sheet has a continuously smooth outer surface in the region of the leading edge, maintaining effective contact of the adhesive roll with the contact cleaning roller in use.

The indicator may extend from the leading edge of at least one adhesive sheet to the roll core.

The adhesive roll may have a first end and an opposing second end. That is the adhesive roll includes a first end and an opposing second end spaced apart along the roll core rotational axis. The indicator may extend radially from at least one adhesive sheet to the roll core at the first end and/or the second end.

The at least one adhesive sheet of the adhesive roll may be a continuous adhesive sheet. The continuous adhesive sheet may be spirally wound onto the roll core.

The at least one adhesive sheet of the adhesive roll may be a plurality of adhesive sheets, wherein each of the plurality of adhesive sheets includes a leading edge and a trailing edge. The plurality of adhesive sheets may be wound successively onto the roll core.

Each adhesive sheet of the plurality of adhesive sheets may have a length that substantially covers a circumference of the roll core and/or the length of an inwardly adjacent adhesive sheet.

The length of each adhesive sheet of the plurality of adhesive sheets may be greater than the circumference of the roll core. The length of each adhesive sheet of the plurality of adhesive sheets may be greater than the length of the adjacent adhesive sheet, that is the inwardly adjacent adhesive sheet.

Each adhesive sheet may include an overlap region in which the leading edge of each adhesive sheet overlaps the trailing edge of that adhesive sheet. In other words, the overlap region provides a region in which the trailing edge and the leading edge of a respective adhesive sheet overlie one another when wound over the roll core.

The adhesive sheet may have an adhesive substrate material including a thermoplastic release layer. Each adhesive sheet may include a thermoplastic release layer. The thermoplastic release layer may be disposed on a lower surface of the adhesive substrate material. That is, the adhesive substrate material includes an adhesive layer disposed on a first surface of the adhesive substrate material, and a thermoplastic release layer disposed on an opposing, second surface of the adhesive substrate material. In this way, the thermoplastic release layer may be disposed on an inwardly facing surface of an adhesive sheet when the adhesive sheet is wound onto the roll core. The outermost layer of adhesive sheet is readily removed from the roll core when the adhesive sheet is spent.

The thermoplastic release layer may include a polyethylene material, such as low density polyethylene or high density polyethylene. The thermoplastic release layer may include a polypropylene material, such as low density polypropylene or high density polypropylene.

The trailing edge may include an indicator. The trailing edge indicator may be the same as the leading edge indicator.

The or each adhesive sheet of the at least one adhesive sheet may have a width and the roll core may have a core width. The width of the or each adhesive sheet may be substantially the same as the core width. The core width and/or the width of the at least one adhesive sheet may correspond to an axial length of the adhesive roll.

The adhesive sheet removal device may be configured to remove an outermost layer of the continuous adhesive sheet. The adhesive sheet removal device may include a cutting element configured to cut the outermost layer of the continuous adhesive sheet from the remainder of the continuous adhesive sheet wound around the roll core of the adhesive roll.

The adhesive sheet removal device may include a detector, typically an optical detector, configured to detect a position of the leading edge of the at least one adhesive sheet. The detector may detect a rotational position of indicator relative to the rotational axis of the adhesive roll.

The detector may include an emitter configured to emit electromagnetic radiation towards the adhesive roll. The emitted electromagnetic radiation may cause a response in the indicator such that the indicator emits light. The emitted light may be a phosphorescence light or a fluorescence light.

The detector may also include an optical sensor configured to detect light emitted from the indicator.

The detector may also include a rotary encoder, preferably a digital rotary encoder, preferably a digital rotary encoder, disposed on the rotational axis of the adhesive roll. The rotary encoder may be configured to measure the rotational position of a successive cut lines made to the adhesive roll. The rotational position of successive leading edges is recorded by the rotary encoder of the detector. In this way, for example when a first length of adhesive sheet is cut from a continuous adhesive sheet, the detector records the rotational position of a second leading edge, that is the leading edge of the most recent cut line on the outer surface of the replenished adhesive roll. Then, when the outer surface is again spent, the contact cleaning system records refers to the rotational position of the most recent cut line to accurately bring the adhesive sheet removal device into contact with the second leading edge and commence removal of a second length of adhesive sheet. The second length may then be cut by another cut line, creating a third leading edge, and the rotary encoder measures the rotational position of the third leading edge ready for later removal of the third length, and so on.

The leading edge of the at least one adhesive sheet may include a fluorescent or phosphorescent indicator. The optical detector may be configured to detect the fluorescent or phosphorescent indicator.

The detector may be operably connected to the adhesive roll and configured to selectively halt the rotation of the adhesive roll.

The contact cleaning system may also include a contact cleaning roller arranged to contact the adhesive roll, in use.

The contact cleaning system may be configured so that the adhesive roll is moveable with respect to the contact cleaning roller. The adhesive roll may be moveable from a contact position, in which the adhesive roll contacts the contact cleaning roller for use removing debris, to a retracted position, in which the adhesive roll is spaced apart from the contact cleaning roller. In the retracted position, the adhesive roll is positioned to engage the adhesive sheet removal device for removal of an adhesive sheet.

In another aspect, there is provided a method of removing an adhesive sheet from an adhesive roll, the method includes: providing an adhesive roll includes at least one adhesive sheet, where the at least one adhesive sheet includes a leading edge; detecting the position of the leading edge; and applying a vacuum to the leading edge of the at least one adhesive sheet to lift the leading edge away from the adhesive roll.

The method may also include transferring the leading edge of the at least one adhesive sheet to a waste roller, and rotating the waste roller to wind the at least one adhesive sheet around the waste roller.

The adhesive sheet removal device may include a cutting element, typically a blade, configured to cut the outermost layer of the at least one adhesive sheet from the adhesive roll at a cut line.

The adhesive sheet removal device may also include an applicator configured to apply an indicator to the at least one adhesive sheet at the cut line.

The cut line may be marked by an indicator before, during or after the cutting of the adhesive substrate material.

The rotational position of the cut line on the adhesive roll may be measured by an detector, for example using a rotary encoder. The leading edge may be rotationally marked using a rotary encoder.

Certain embodiments provide an advantage that an end, that is a leading edge, of an adhesive sheet is easily and quickly identified. In particular, the rotational position of the leading edge relative to the roll core is easily marked for identification. Identification of the rotational position of the leading edge is automated so that contact cleaning system identifies the leading edge without unnecessary down time. Manual inspection of the adhesive sheet is no longer required.

Certain embodiments ensures a spent adhesive sheet is removed from the adhesive roll in a reduced time, increasing the operating efficiency of the contact cleaning system. An adhesive roll with a spent adhesive sheet is rotationally aligned to coordinate with the adhesive sheet removal device. Down time for the contact cleaning system is reduced.

Certain embodiments enable a leading edge to be lifted from the adhesive roll without risk of damage to the underlying adhesive sheet.

Certain embodiments provide a simple, convenient method of marking a leading edge of an adhesive sheet. The leading edge may be marked prior to installation of the adhesive roll, reducing the cost of the contact cleaning system. The leading edge may be marked each time a spent adhesive sheet is removed, increasing reliability of the adhesive sheet removal device.

Certain embodiments are easily secured to a waste roller once removed from the adhesive roll. In particular, the inventors have advantageously utilised the thermoplastic release layer to further provide a thermal bond between the waste roller and any received adhesive sheet wound around the waste roller.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the disclosure are now described, by way of example only, with reference to the accompanying drawings in which:

FIG. 1 shows a schematic view of an example contact cleaning system including an adhesive sheet removal device;

FIG. 2 shows a schematic view of an example adhesive roll having a plurality of adhesive sheets;

FIG. 3 shows a schematic view of another example adhesive roll having a continuous adhesive sheet; and

FIG. 4A to FIG. 4G show certain steps by which an example adhesive sheet removal device is used to remove an adhesive sheet from an adhesive roll of a contact cleaning system.

### DETAILED DESCRIPTION

Certain terminology is used in the following description for convenience only and is not limiting. The words ‘inner’, ‘inwardly’, ‘outer’ and ‘outwardly’ refer to directions toward and away from, respectively, a designated centreline or a geometric centre of an element being described (e.g. central axis), the particular meaning being readily apparent from the context of the description.

Further, as used herein, the terms ‘connected’ and ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second” and “third” etc. merely indicate that different instances of like objects are being referred to and are not intended to imply that the objects so described must be in a given sequence, either temporally, spatially, in ranking or in any other manner.

Like reference numerals are used to depict like features throughout.

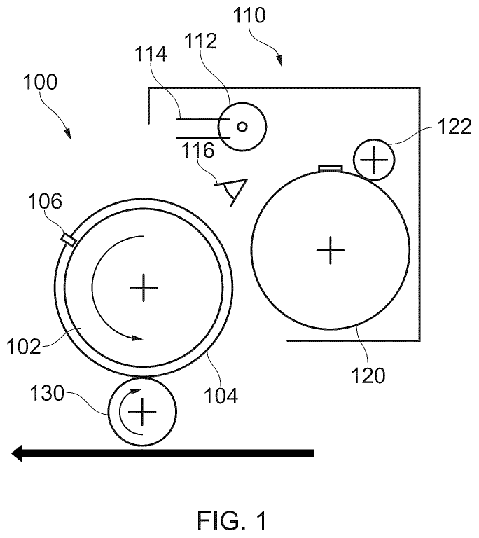

Referring now to FIG. 1, there is shown a contact cleaning system 100 with an adhesive roll 102 including an adhesive sheet 104 wound over a roll core. The adhesive sheet 104 includes a leading edge 106 with an indicator.

The adhesive roll 102 is mounted for use in the contact cleaning system 100 to contactingly engage a contact cleaning roller 130 for removing debris from a substrate surface 132. The adhesive roll 102 and contact cleaning roller 130 are mounted to rotatingly contact one another. The outermost adhesive sheet 104 contacts the outer surface of the contact cleaning roller 130 to remove debris from the outer surface that has collected from the substrate surface 132.

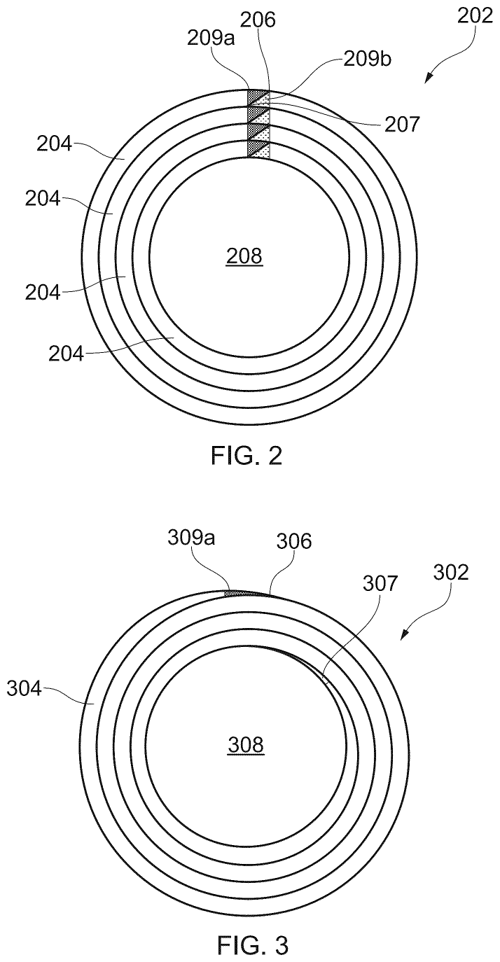

The adhesive roll 102 may include a continuous adhesive sheet, such described below with reference to FIG. 2. Alternatively, the adhesive roll may include a plurality of adhesive sheets, such as described below with reference to FIG. 3.

Regardless of whether the adhesive roll 102 includes a continuous adhesive sheet and/or a plurality of adhesive sheets, the adhesive roll 102 is substantially cylindrical. The or each adhesive sheet on the roll core has a width corresponding to the axial length of the adhesive roll 102. Furthermore, the leading edge 106 extends, or is cut to extend, substantially the axial length of the adhesive roll 102, typically in parallel to the rotational axis of the adhesive roll 102.

In further examples, not shown, the leading edge may extend in alternative directions to parallel to the rotational axis, such as at a diagonal across the axial length of the adhesive roll. For example, the leading edge may wrap helically around the adhesive roll

In further examples, the leading edge may be cut at an angle, to provide a tapered leading edge. A leading edge cut at an angle forms a gradually inclined surface at the boundary between layers of adhesive sheet.

The contact cleaning system 100 includes an adhesive sheet removal device 110 for removing an outermost layer of the adhesive sheet 104 from the adhesive roll 102, for example when the adhesive sheet 104 is spent. The adhesive sheet removal device 110 includes a waste roller 120 and a pick-up element 112.

The pick-up element 112 is pivotable relative to the adhesive roll 102. The pick-up element 112 is pivotable from a pick-up position, in which the pick-up element 112 is oriented towards the adhesive roll 102 for lifting the leading edge 106 of the outermost layer of the adhesive sheet 104, to a transfer position, in which the hollow element 114 is oriented towards the waste roller 120 to transfer the leading edge 106 onto the waste roller 120.

The pick-up element 112 is also pivotable to a stowed position in which the pick-up element 112 is disengaged from adhesive roll 102 and from the waste roller 120.

The pick-up element 112 is operable connected to a vacuum source (not shown) so as to apply a vacuum to the adhesive roll 102. The pick-up element 112 is configured to convey the applied vacuum from the vacuum source to the adhesive roll 102. In particular, the pick-up element 112 includes a hollow element 114 configured to direct the applied vacuum from the pick-up element 112 towards the adhesive roll 102.

The hollow element 114 is operably connected to the vacuum source via the pick-up element 112. Suitably, the hollow element 114 is an elongate channel with a length substantially as long as the axial length of the adhesive roll 102. In this way, with the pick-up element 112 oriented in the pick-up position, a vacuum is applied along the entire the leading edge 106 of the outermost layer of adhesive sheet 104.

In further examples, pick-up element may apply a vacuum to the leading edge using a series of vacuum pockets configured to align along the axial length of the adhesive roll. For example, the vacuum source may include a series of hollow elements arranged to be spaced along the axial length of the adhesive roll in use. The series of hollow elements may be spaced apart from one another along the axial length. In this way, the pick-up element may be adapted to apply the vacuum intermittently along the leading edge. The applied vacuum is thereby more intense in localised regions along the leading edge.

The pick-up element 112 conveys the applied vacuum to apply a sheer force to the leading edge 106 of the outermost adhesive sheet on the adhesive roll 102 to lift the leading edge 106 away from the adhesive roll 102. The vacuum is applied to the leading edge 106 of the outermost layer of the at least one adhesive sheet 104 so as to lift the leading edge 106 away from the underlying adhesive sheet 104 or roll core 108. That is, the applied vacuum lifts the leading edge 106 away from one of: an inwardly adjacent layer of the at least one adhesive sheet 104, or the roll core 108.

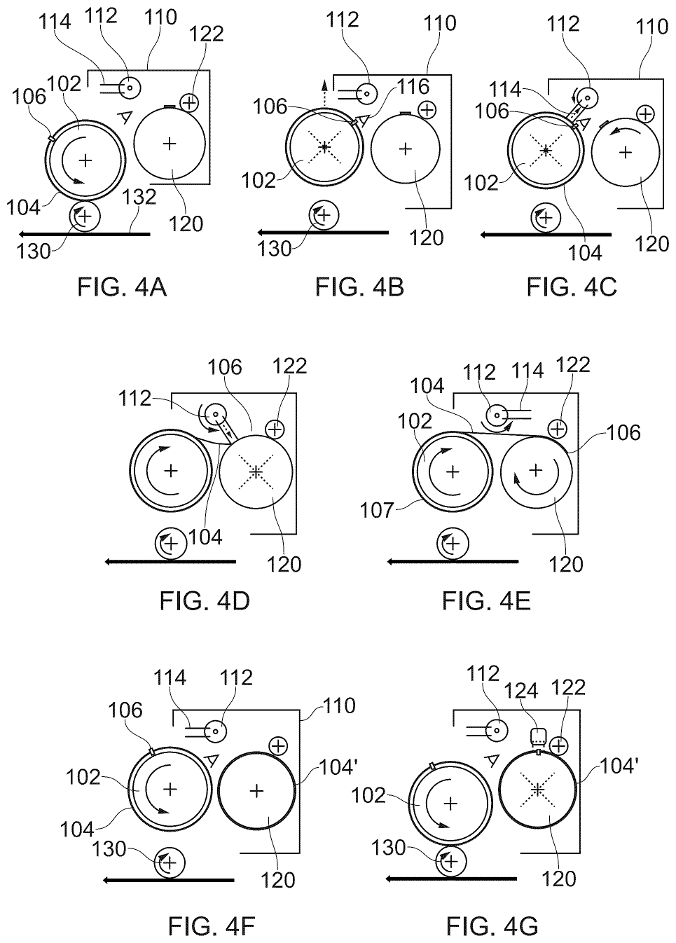

Once the pick-up element 112 has lifted the leading edge 106, the leading edge 106 of the at least one adhesive sheet 104 is transferred to the waste roller 120. The waste roller 120 is rotatable relative to the adhesive sheet removal device 110. The waste roller 120 is positioned in the adhesive sheet removal device 110 to cooperate with the pick-up element 112 to transfer the leading edge 106 and the adhesive sheet 104 to the waste roller 120, as described in more detail with reference to FIG. 4A to FIG. 4G.

The contact cleaning system 100 includes a detector, in this example an optical detector 116. The optical detector 116 is positioned within the contact cleaning system 100 to monitor the outermost adhesive sheet 104 of the adhesive roll 102. In particular, the optical detector 116 is positioned to monitor the outermost adhesive sheet 104 when the adhesive roll 102 is in a retracted position, as explained below with reference to FIG. 4B.

The optical detector 116 is configured to detect a position of the indicator at the leading edge 106 of the adhesive sheet 104. That is, the optical detector 116 is configured to detect a rotational position of the indicator, and thereby the leading edge 106, around the rotational axis of the adhesive roll 102.

The optical detector 116 includes an emitter and an optical sensor. The optical sensor is configured to detect light emitted from the indicator on the adhesive roll 102. The emitter is configured to emit electromagnetic radiation towards the adhesive roll 102. The emitted radiation causes a response in the indicator such that the indicator emits light which is detected by the optical sensor. For example, in response to electromagnetic radiation from the emitter, the indicator may fluoresce or phosphoresce depending on the choice of indicator. The optical sensor is thereby selected to detect the associated fluorescence or phosphorescence produced by the indicator.

The optical detector 116 is oriented to detect when the leading edge 106 is oriented, that is rotationally oriented, to be engaged by the pick-up element 112 of the adhesive sheet removal device 110 for removal from the adhesive roll 102. In this way, the adhesive roll 102 may be rotated until the optical detector 116 detects that the leading edge 106 has reached a predetermined orientation, at which point, the optical detector 116 causes the adhesive roll 102 to stop rotating. The optical detector 116 thereby ensures the adhesive roll 102 is halted in an optimal position for the outermost layer of adhesive sheet 104 to be engaged by the pick-up element 112. Preferably, the optimal position corresponds with the pick-up position of the pick-up element 112, facilitating removal from the adhesive roll 102.

The adhesive sheet removal device 110 further includes a heating element 124 and a pressure element 122, arranged to be operable with the waste roller 120. The heating element 124 and pressure element 122 process the adhesive sheet 104 received by the waste roller 120 as it is removed the outermost layer of adhesive sheet 104. The spent adhesive sheet 104 is thereby secured on the waste roller 120.

The pressure element 122 is configured to apply a pressure to the received adhesive sheet 104′ (shown in FIG. 4F) as it contacts the waste roller 120. The applied pressure causes the adhesive sheet 104 to adhere to the waste roller 120. The heating element 124 applies heat to the received adhesive sheet 104 as it contacts the waste roller 120. The applied heat causes the adhesive sheet 104 to adhere to the waste roller 120.

In the example shown, the pressure element 122 is arranged proximal to the heating element 124 such that the spent adhesive sheet 104 that has been removed from the adhesive roll 102 is heated and pressed against the waste roller 120 as it comes into contact with the waste roller 120. In particular, when the spent adhesive sheet includes thermoplastic release layer, the application of heat and/or pressure by the heating element and pressure element softens the material of the thermoplastic release layer, causing flow. The received adhesive sheet 104′ bonds to the waste roller 120 due to flow of the thermoplastic release layer. The received adhesive sheet 104′ is secured to the waste roller 120 by thermally binding the thermoplastic release layer. Thus, in use, typically the thermoplastic release layer is sandwiched between the waste roller 120 and the outer layers of the received adhesive sheet 104′ and heated by the heating element 124. Pressure is then applied causing the thermoplastic release layer to bond to the waste roller 120. The heated area is then cooled before releasing the pressure, resulting in a bond between the received adhesive sheet 104′ and the waste roller 120.

In other configurations, the adhesive sheet removal device 110 may be provided with only a pressure element, only a heating element, or any suitable combination of pressure element and heating element as is necessary based on the properties of the adhesive sheet 104, to secure the received adhesive sheet 104′ to the waste roller installed in the contact cleaning system.

Optionally, the adhesive sheet removal device may include a cutting element, such as a blade. The cutting element may be configured to cut the outermost layer of the adhesive sheet, typically a continuous adhesive sheet, from the adhesive roll at a cut line. The cutting element severs the adhesive sheet from the remainder of the adhesive roll wound around the roll core. The adhesive sheet removal device may be configured to cut the adhesive sheet once a length of adhesive sheet, typically corresponding to a circumference of the adhesive roll, has been removed by the adhesive sheet removal device.

Optionally, the adhesive sheet removal device may include an applicator. The applicator may be configured to apply an indicator to the at least one adhesive sheet at the cut line. In this way, the leading edge of an outermost layer of adhesive sheet is marked for detection by the detector. The applicator may apply the indicator after, typically immediately after, a prior outermost layer of adhesive sheet has been removed from the adhesive roll by the adhesive sheet removal device.

Referring now to FIG. 2, there is shown an adhesive roll 202 having a plurality of adhesive sheets. The plurality of adhesive sheets are wrapped successively around the roll core 208 to form a series of adhesive sheets 204 for replenishment of the adhesive roll 202 in use.

Each of the plurality of adhesive sheets 204 includes a leading edge 206 and a trailing edge 207. Preferably, the trailing edge 207 of a layer of adhesive sheet 204 abuts the leading edge 206 of the same adhesive sheet 204. That is, each adhesive sheet 204 forms a continuous layer on the adhesive roll 202 so that the leading edge 206 and trailing edge 207 of any particular adhesive sheet 204 meet one another. Typically, there is an overlap region in which the leading edge 206 of each adhesive sheet 204 overlaps the trailing edge 207 of that adhesive sheet 204.

In this way, an innermost adhesive sheet 204 of the plurality of adhesive sheets has a length that substantially covers a circumference of the roll core 208. Each successive adhesive sheet 204 has a length that substantially covers the inwardly adjacent adhesive sheet. Stated differently, the length of each adhesive sheet 204 of the plurality of adhesive sheets is greater than the circumference of the roll core and/or the length of the inwardly adjacent adhesive sheet.

Each leading edge 206 includes an indicator 209a, such as a phosphorescent indicator or a fluorescent indicator. Each trailing edge 207 includes an indicator 209b, such as the phosphorescent indicator or the fluorescent indicator. The indicator 209a of the leading edge 206 is the same as the indicator 209b of the trailing edge 207. Optionally, the respective indicators of the leading edge 206 and trailing edge 207 may be different to one another.

The adhesive roll 202 shown in FIG. 2 may be formed according to the following method. In a first step, an adhesive substrate material is provided. The adhesive substrate material is suitable for removing debris from a contact cleaning roller. Typically, the adhesive substrate material has a width corresponding to the axial length of a roll core on which the adhesive roll is to be formed.

In a following step, the adhesive substrate material is cut at a cut line to provide an adhesive sheet. The adhesive sheet has a length corresponding to the circumference of the roll core. The cut line forms a trailing edge of the adhesive sheet that is cut from the adhesive substrate material. The cut line also forms a leading edge of a successive adhesive sheet cut that is provided from the remaining adhesive substrate material.

In a further step, the cut line of the adhesive sheet is marked with an indicator. In this way, the trailing edge of a first adhesive sheet and the leading edge of a successive adhesive sheet are each marked with the indicator in a single operation.

In a final step, the adhesive sheet is wound about the roll core. An adhesive roll with an adhesive sheet as described herein is formed.

In use, the adhesive roll 202 is arranged in a contact cleaning system to remove debris from a contact cleaning roller. The contact cleaning system may be the contact cleaning system 100 described above. When the outermost layer of the adhesive sheet 204 is spent, the detector of the contact cleaning system detects the indicator at the leading edge and the outermost layer removed by the adhesive sheet removal device 110. A fresh outermost layer of adhesive sheet 204 is thus revealed in order to continue removing debris from the contact cleaning roller.

Referring now to FIG. 3, there is shown an adhesive roll 302 having an adhesive sheet 304, wherein the adhesive sheet 304 is a continuous adhesive sheet.

The adhesive sheet 304 of the adhesive roll 302 is wound around the roll core 308 several times over. The adhesive sheet 304 has a length corresponding to a plurality of circumferences of the roll core 308.

The adhesive roll 302 is formed with a trailing edge 307 of the adhesive sheet 304 directly contacting the roll core 308 and a leading edge 306 exposed at the end of an outermost layer of the adhesive sheet 304. The leading edge 306 includes an indicator 309a, such as a phosphorescent indicator or a fluorescent indicator.

In use, the adhesive roll 302 is arranged in a contact cleaning system to remove debris from a contact cleaning roller. The contact cleaning system may be the contact cleaning system 100 described above, including a cutting element and an applicator. When the outermost layer of the adhesive sheet 304 is spent, the detector of the contact cleaning system detects the indicator 309a at the leading edge 306 and a length of adhesive sheet 304 corresponding to the circumference of the outermost layer is removed by the adhesive sheet removal device 110. The cutting element cuts the outermost layer of the adhesive sheet 304 at a cut line. The applicator applies an indicator to the cut line. When the severed length of adhesive sheet is removed using its leading edge, a fresh outermost layer of adhesive sheet 304 is revealed to continue removing debris from the contact cleaning roller.

Referring now to FIG. 4A to FIG. 4G, there is shown a process by which the adhesive sheet removal device 110 of the contact cleaning system 100 removes an outermost layer of adhesive sheet 104.

Turning to FIG. 4A, there is shown the contact cleaning system 100 in use cleaning a substrate surface 132. The contact cleaning roller 130 is actively removing debris from the substrate surface 132, and the adhesive roll 102 is contactingly engaged with the contact cleaning roller 130 to remove the debris from the contact cleaning roller 130. The adhesive roll 102 is in the contact position with respect to the contact cleaning roller 130. The adhesive sheet removal device 110 is not in use.

The contact cleaning roller 130 continues removing debris from the substrate surface 132 until the performance of the adhesive roll 102 falls below the required threshold the adhesive. Once performance falls below the threshold the outermost layer of the adhesive sheet 104 on the adhesive roll 102 is spent and must be removed from the adhesive roll 102.

Turning to FIG. 4B, the contact cleaning system 100 is shown at an initial stage for removing the outermost layer of the adhesive sheet 104. The adhesive roll 102 is disengaged from the contact cleaning roller 130 by moving adhesive roll axis away from the contact cleaning roller 130. The adhesive roll 102 is thereby moved to a retracted position, so as to be operably engaged with the adhesive sheet removal device 110.

Within the adhesive sheet removal device 110, the optical detector 116 is activated to detect the position of the leading edge 106 of the outermost adhesive sheet 104. The pick-up element 112 is positioned in the stowed position.

The adhesive roll 102 continues to rotate until the optical detector 116 detects that the leading edge 106 is in an optimal position for transfer. The adhesive roll 102 is halted in the optimal position.

Turning to FIG. 4C, the contact cleaning system 100 is shown with the adhesive sheet removal device 110 engaged with the adhesive roll 102 in the optimal position. The pick-up element 112 is pivoted to the pick-up position so that the hollow element 114 is directed towards the leading edge 106.

Once in the pick-up position, the pick-up element 112 applies a vacuum to the leading edge 106, lifting the leading edge 106 of the outermost adhesive sheet 104, the spent adhesive sheet 104, away from the adhesive roll 102.

Turning to FIG. 4D, the pick-up element 112 is shown pivoted to the transfer position. The pick-up element 112 is oriented towards the waste roller 120. The waste roller 120 is static.

The leading edge 106 is held against the hollow element 114 by the applied vacuum as the pick-up element 112 pivots from the pick-up position to the transfer position. In this way, the leading edge 106 is transferred from the adhesive roll 102 to the waste roller 120. Consequently the following portion of the spent adhesive sheet 104 is also lifted from the 102 and drawn towards the waste roller 120.

The leading edge 106 engages the waste roller 120 and the waste roller 120 commences rotating. As the waste roller 120 rotates, the pick-up element 112 ceases to apply the vacuum, releasing the leading edge 106 from the hollow element 114. The rotating waste roller 120 engages the leading edge 106 so that the leading edge 106 rotates with the waste roller 120. The rotation of the waste roller 120 begins the transfer of the outermost layer of adhesive sheet 104 to the waste roller 120.

Turning to FIG. 4E, the waste roller 120 is shown a short time after it has commenced rotation. The leading edge 106 of the spent adhesive sheet 104 is wound partly around the waste roller 120 and beyond the pressure element 122. Thus, the pressure element 122 has applied pressure to the received adhesive sheet 104′, causing the received adhesive sheet 104′ to adhere to the waste roller 120.

Rotation of the waste roller 120 continues thereafter, winding the leading edge 106 further around the waste roller 120. The rotation of the waste roller 120 unwinds the spent adhesive sheet 104 from the adhesive roll 102 and winds the same layer onto the waste roller 120.

In the example shown, the adhesive roll 102 is an adhesive roll 102 with a plurality of adhesive sheets, such as the adhesive roll 202 described with reference to FIG. 2. In this way, the adhesive sheet 104 is unwound from the adhesive roll 102 until its trailing edge 107 is lifted from the adhesive roll 102. The waste roller 120 continues rotating until the trailing edge 107 is received on the waste roller 120.

In other examples, such as where the adhesive roll includes a continuous adhesive sheet, the adhesive sheet may be unwound from the adhesive roll until a predetermined first length of the continuous adhesive sheet is lifted from the adhesive roll. After a first length is unwound, the continuous adhesive sheet is cut at a cut line to detach an adhesive sheet of the first length. The remainder of the continuous adhesive sheet, including a new leading edge, remains on the adhesive roll to provide a replenished outer surface in order for the adhesive roll to resume cleaning of the contact cleaning roller.

The cut line of the remainder of the continuous adhesive sheet, may be marked with an indicator, or the rotational position of the leading edge on the adhesive roll may be recorded using a rotary encoder. In this way, when the replenished outer surface becomes spent, the leading edge may be conveniently rotationally aligned with the pick-up element to remove a second length of the continuous adhesive sheet.

Turning to FIG. 4F, the contact cleaning system 100 is shown with the received adhesive sheet 104′ wrapped around the waste roller 120. The adhesive roll 102 has a new outermost layer of adhesive sheet 104 with fresh layer of adhesive available to engage the contact cleaning roller 130 and restart debris removal. The adhesive roll 102 is replenished.

The pick-up element 112 is returned to its stowed position in the adhesive sheet removal device 110.

Turning to FIG. 4G, the contact cleaning system 100 is shown with the adhesive roll 102 moved back to the contact position, in which the adhesive roll 102 is contactingly engaged with the contact cleaning roller 130 to remove debris from the contact cleaning roller 130 in use.

The adhesive sheet removal device 110 remains active to process the received adhesive sheet 104′. Thus the waste roller 120 continues to rotate so that the pressure element 122 applies pressure to the received adhesive sheet 104′. Furthermore, the heating element 124 is energised to apply heat to the received adhesive sheet 104 in combination with pressure applied by the pressure element 122.

After a suitable time period, such as a time period in the range from 5 seconds to 10 seconds, the received adhesive sheet 104′ is sufficiently adhered to the waste roller 120. The pressure element 122 and heating element 124 are deactivated, and rotation of the waste roller 120 is halted. The adhesive sheet removal device 110 is thereby on standby to remove the next adhesive sheet 104 from the adhesive roll 102 when its cleaning performance falls below the predetermined threshold.

Optionally, the process shown in FIG. 4A to FIG. 4G contact cleaning system 100 may be carried out using an adhesive roll having a continuous adhesive sheet, such as described with reference to FIG. 3. To accommodate this, the adhesive sheet removal device may include a cutting element and applicator as described herein. In this way the adhesive sheet removal device is configured to cut the continuous adhesive sheet after a length of adhesive sheet corresponding to a circumference of the outermost layer of adhesive sheet 104 is transferred to waste roller. The transferred length of adhesive sheet 104 is sufficient to uncover a fresh outermost layer of the adhesive sheet 104. The adhesive roll is replenished.

The adhesive sheet removal device is also configured to apply an indicator to the leading edge of the fresh outermost layer ready for detection by the detector.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. The disclosure extends to any novel one, or any novel combination, of the features disclosed in this specification (including any accompanying claims, abstract or drawings), or to any novel one, or any novel combination, of the steps of any method or process so disclosed.

What is claimed is:

1. A contact cleaning system comprising:
an adhesive roll comprising at least one adhesive sheet, wherein the at least one adhesive sheet comprises a leading edge; and
an adhesive sheet removal device comprising a pick-up element;
wherein the pick-up element is configured to be brought into contact with the leading edge of the at least one adhesive sheet and apply a vacuum to the leading edge to lift the leading edge away from the adhesive roll.

2. The contact cleaning system of claim 1, wherein the vacuum of the pick-up element applies a sheer force to the leading edge of the at least one adhesive sheet to lift the leading edge away from the adhesive roll.

3. The contact cleaning system of claim 1, wherein the pick-up element comprises a hollow element configured to convey the vacuum to the leading edge of the at least one adhesive sheet.

4. The contact cleaning system of claim 1, wherein the adhesive sheet removal device further comprises a waste roller, and wherein the pick-up element is configured to transfer the leading edge of the at least one adhesive sheet to the waste roller.

5. The contact cleaning system of claim 4, wherein the pick-up element is pivotable between the adhesive roll and the waste roller to transfer the leading edge of the at least one adhesive sheet to the waste roller.

6. The contact cleaning system of claim 4, wherein the pick-up element is translatable along a longitudinal axis between the adhesive roll and the waste roller to transfer the leading edge of the at least one adhesive sheet to the waste roller.

7. The contact cleaning system of claim 4, wherein the adhesive sheet removal device further comprises a heating element configured to heat the at least one adhesive sheet that is received by the waste roller.

8. The contact cleaning system of claim 7, wherein the adhesive sheet removal device comprises a pressure element configured to apply a pressure to the at least one adhesive sheet as it comes into contact with the waste roller to adhere the at least one adhesive sheet to the waste roller.

9. The contact cleaning system of claim 8, wherein the heating element comprises the pressure element such that the at least one adhesive sheet removed from the adhesive roll is heated and pressed against the waste roller as it comes into contact with the waste roller.

10. The contact cleaning system of claim 1, wherein the adhesive roll comprises a plurality of adhesive sheets wound around a roll core.

11. The contact cleaning system of claim 1, wherein the adhesive roll comprises a continuous adhesive sheet wound around the roll core.

12. The contact cleaning system of claim 11, wherein the adhesive sheet removal device is configured to remove an outermost layer of the continuous adhesive sheet and wherein the adhesive sheet removal device comprises a cutting element configured to cut the outermost layer of the continuous adhesive sheet from the remainder of the continuous adhesive sheet wound around the roll core of the adhesive roll.

13. The contact cleaning system of claim 12, further comprising a digital rotary encoder to configured to record the rotational position of a leading edge of the remainder of the continuous adhesive sheet wound around the roll core of the adhesive roll.

14. The contact cleaning system of claim 1, wherein the adhesive sheet removal device comprises an optical detector configured to detect a position of the leading edge of the at least one adhesive sheet.

15. The contact cleaning system of claim 14, wherein the leading edge of the at least one adhesive sheet comprises a fluorescent or phosphorescent indicator, and wherein the optical detector is configured to detect the fluorescent or phosphorescent indicator.

16. The contact cleaning system of claim 1, wherein the contact cleaning system further comprises a contact cleaning roller arranged to contact the adhesive roll while in use.

17. A method of removing an adhesive sheet from an adhesive roll, the method comprising:
providing an adhesive roll comprising at least one adhesive sheet, wherein the at least one adhesive sheet comprises a leading edge;
detecting the position of the leading edge; and
applying a vacuum to the leading edge of the at least one adhesive sheet to lift the leading edge away from the adhesive roll.

18. The method of claim 17, further comprising:
transferring the leading edge of the at least one adhesive sheet to a waste roller; and
rotating the waste roller to wind the at least one adhesive sheet around the waste roller.

19. The method of claim 18, wherein the at least one adhesive sheet is a continuous adhesive sheet and the method further comprises:
cutting the continuous adhesive sheet at a cut line to provide a first length of adhesive sheet for removal from the adhesive roll.

20. The method of claim 19, further comprising one or both of:
marking the cut line with an indicator; or
measuring the rotational position of the cut line on the adhesive roll, typically with a rotary encoder.
